(19) United States
(12) Patent Application Publication
(10) Pub. No.: US 2026/0125233 A1
(43) Pub. Date: May 7, 2026

(54) IMAGE FORMING APPARATUS AND IMAGE FORMING METHOD

(71) Applicant: Konica Minolta, Inc., Tokyo (JP)

(72) Inventor: Toshiaki TOMINO, Tokyo (JP)

(21) Appl. No.: 19/374,705

(22) Filed: Oct. 30, 2025

(30) Foreign Application Priority Data
Nov. 5, 2024 (JP) 2024-193656

(51) Int. Cl. B65H 5/36

(52) U.S. Cl. CPC B65H 5/36; B65H 2301/5133; B65H 2801/03

(57) ABSTRACT

An image forming apparatus includes a static charge neutralizer that neutralizes a static charge of a recording medium to be conveyed. The static charge neutralizer includes a dielectric, a discharge electrode, and an induction electrode. The discharge electrode and the induction electrode are disposed in the dielectric. In one embodiment, the image forming apparatus further includes a guide member that guides the recording medium, and the guide member contains a metal material.

### CROSS REFERENCE TO RELATED APPLICATIONS

The entire disclosure of Japanese Patent Application No. 2024-193656, filed on November 5, 2024, is incorporated herein by reference in its entirety.

### BACKGROUND

### Technological Field

The present invention relates to an image forming apparatus and an image forming method.

### Description of Related Art

In the related art, there is known, for example, an image forming apparatus using an electrophotographic method or an electrostatic recording method. It is known that such an image forming apparatus is provided with a static charge neutralizer that neutralizes static electricity generated in a recording medium (e.g., a sheet or the like), on which an image is formed. For example, Japanese Patent Application Laid-Open No. 2023-70377 discloses an image forming apparatus provided with a static charge neutralizer.

### SUMMARY

The static charge neutralizer of the image forming apparatus disclosed in Japanese Patent Application Laid-Open No. 2023-70377 includes two needle-like electrodes that face each other, and a static charge of a recording medium that passes between the two needle-like electrodes is neutralized by performing corona discharge on the recording medium. However, such a static charge neutralizer includes two needle-like electrodes facing each other, and therefore requires a large installation space.

An object of the present invention is to provide an image forming apparatus including a static charge neutralizer that can be installed in a limited space.

In order to achieve at least one of the above-mentioned objects, an image forming apparatus reflecting one aspect of the present invention is an image forming apparatus including a static charge neutralizer that neutralizes a static charge of a recording medium to be conveyed. The static charge neutralizer includes a dielectric, a discharge electrode, and an induction electrode. The discharge electrode and the induction electrode are disposed in the dielectric.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a side view of an overall configuration of an image forming apparatus according to an embodiment;

FIG. 1B is a perspective view of a static charge neutralizing unit including a static charge neutralizer;

FIG. 2A is a cross-sectional view of the static charge neutralizer;

FIG. 2B is a schematic diagram of a dielectric in which electrodes are disposed;

FIG. 3A is a cross-sectional view of the static charge neutralizer;

FIG. 3B is a flowchart for detecting a charged state and controlling the activation of the static charge neutralizer; and

FIG. 4 is a graph illustrating a relationship between a discharge distance and the charged state.

### DETAILED DESCRIPTION OF EMBODIMENTS

Hereinafter, one or more embodiments of the present invention will be described with reference to the drawing. However, the scope of the invention is not limited to the disclosed embodiments.

Hereinafter, an image forming apparatus according to an embodiment of the present invention will be described with reference to the accompanying drawings. The image-formed product according to the embodiment to be described below is an example, and the present invention is not limited to this embodiment.

### Overall Configuration of Image Forming Apparatus

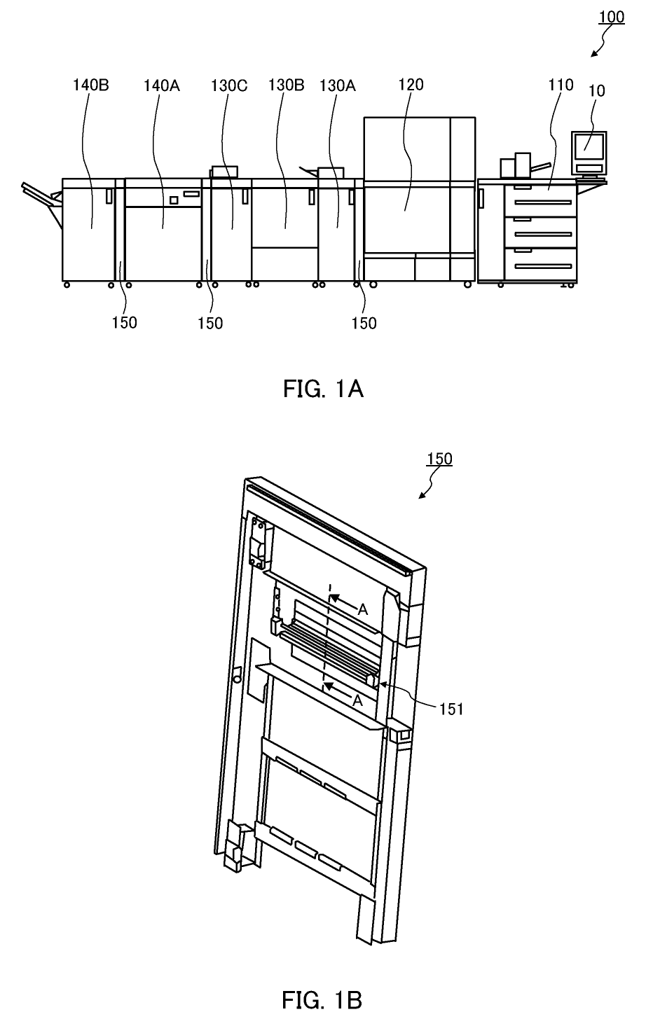

FIG. 1A is a side view of an overall configuration of an image forming apparatus 100. As illustrated in FIG. 1A, the image forming apparatus 100 includes a sheet feed unit 110, an image forming unit 120, non-loading units 130A, 130B, and 130C, loading units 140A and 140B, and static charge neutralizing units 150.

In the image forming apparatus 100, a recording medium (e.g., a sheet) fed from the sheet feed unit 110 is conveyed to the image forming unit 120, and an image is formed thereon to form an image-formed product (e.g., a sheet on which an image has been formed). The image-formed product passes through the static charge neutralizing unit 150, a static charge of the image-formed product is neutralized, and the image-formed product is sequentially conveyed to the non-loading units 130A, 130B, and 130C. These non-loading units 130A to 130C perform operations other than loading of the image-formed product as necessary.

Specifically, each of the non-loading units 130A to 130C performs the following operations as necessary. The non-loading unit 130A corrects a curl of the image-formed product. The non-loading unit 130B detects the position where the image of the image-formed product has been formed. The non-loading unit 130C has a function of folding the image-formed product. Examples of the folding include various folding methods such as tri-fold, four-fold, and gate-fold.

The image-formed product that has passed through the non-loading units 130A to 130C passes through the static charge neutralizing unit 150, a static charge of the image-formed product is neutralized, and the image-formed product is conveyed to the loading unit 140A for loading. The loading unit 140A binds the folded image-formed products and loads the bound product. Further, the image-formed product that is not bound by the loading unit 140A passes through the loading unit 140A, a static charge of the image-formed product is neutralized by a static charge neutralizing unit 150, and the image-formed product is conveyed to the loading unit 140B. At the loading unit 140B, the unfolded image-formed product is loaded.

The recording medium whose static charge is neutralized in the image forming apparatus 100 may or may not have an image formed thereon. The recording medium is not particularly limited as long as an image can be formed thereon. Examples of the recording medium include a sheet and a film.

Hereinafter, details of each unit included in the image forming apparatus 100 will be described. First, details of the static charge neutralizing unit 150 will be described, and then details of the units other than the static charge neutralizing unit 150 will be described.

### Static Charge Neutralizing Unit

FIG. 1B is a perspective view of the static charge neutralizing unit 150. As illustrated in FIG. 1B, the static charge neutralizing unit 150 has a thin plate shape in appearance. As illustrated in FIG. 1B, the static charge neutralizing unit 150 includes a static charge neutralizer 151 that exhibits a static charge neutralizing function. A static charge of the recording medium that has passed through the static charge neutralizer 151 of the static charge neutralizing unit 150 is neutralized. In the static charge neutralizing unit 150, the static charge neutralizer 151 is disposed at a height position corresponding to the conveyance path of the recording medium of the image forming apparatus 100. That is, in the static charge neutralizing unit 150, the static charge neutralizer 151 is disposed so as to be at the same height as the conveyance exit of the unit disposed immediately before the static charge neutralizing unit 150 and the conveyance entrance of the unit disposed immediately after the static charge neutralizing unit 150.

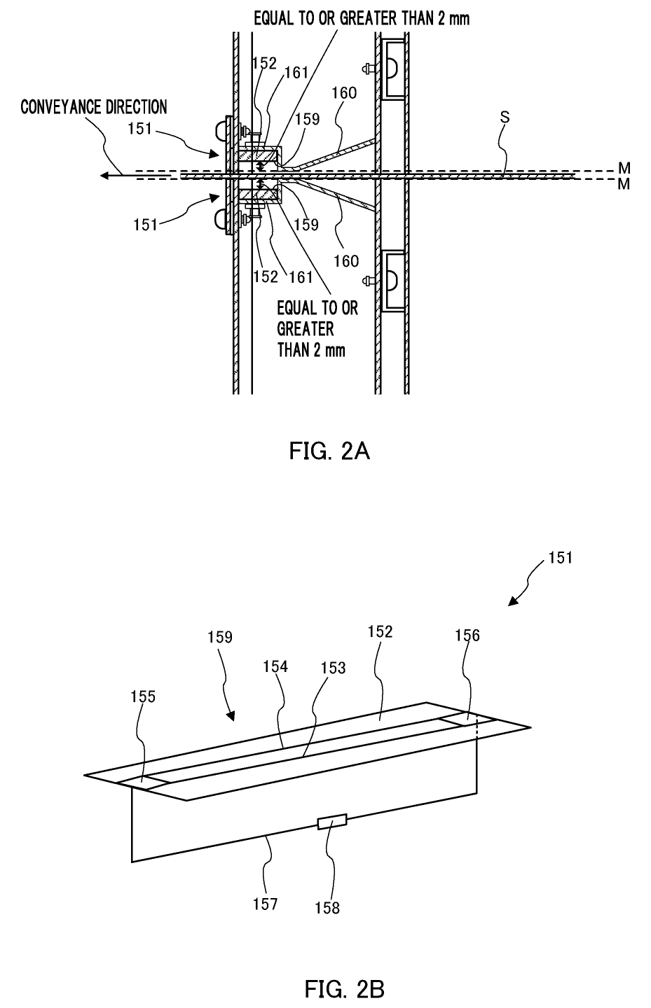

FIG. 2A is a cross-sectional view of the static charge neutralizer 151 illustrated in FIG. 1B, taken along line A-A. Note that, a recording medium S is also illustrated in FIG. 2A for description. FIG. 2B is a schematic diagram of the static charge neutralizer 151. As illustrated in FIG. 2A, the static charge neutralizer 151 includes a dielectric 152 in which electrodes are disposed at positions facing each other with the recording medium S being held between the positions. The dielectric 152 disposed in this manner neutralizes a static charge of the recording medium S that has been conveyed.

As illustrated in FIG. 2B, the dielectric 152 includes a discharge electrode 153, an induction electrode 154, power supply terminals 155 and 156, a conductor 157, and a power supply 158.

When a voltage is applied from the power supply 158, a current flows through the discharge electrode 153 and the induction electrode 154 via the conductor 157 and the power supply terminals 155 and 156. When a current flows through the discharge electrode 153 and the induction electrode 154, corona discharge occurs. A static charge of the recording medium S is neutralized by the generated corona discharge. The static charge neutralizer 151 having the above-described configuration is compact and is easy to install even when there is a limitation on the installation space. In addition, since corona discharge occurs in a limited region, safety is high.

The dielectric 152 is not particularly limited as long as the discharge electrode 153 and the induction electrode 154 can be disposed therein. The dielectric 152 has a sheet shape, a film shape, or a plate shape. In the present embodiment, the dielectric 152 has an elongated plate shape. The dielectric 152 includes two main surfaces that are orthogonal to the thickness direction of the dielectric 152 and correspond to the front surface and the back surface of the dielectric 152. The discharge electrode 153, the induction electrode 154, and the power supply terminals 155 and 156 as described above are disposed in one of the two main surfaces. The main surface in which the discharge electrode 153, the induction electrode 154, and the power supply terminals 155 and 156 are disposed faces the recording medium S and serves as a discharge surface 159 having capability of neutralizing a static charge of the recording medium S in a non-contact manner. The size of the dielectric 152 may be appropriately set according to the size of the recording medium S. Specifically, the length of the dielectric 152 in the longitudinal direction is preferably substantially the same as or longer than the width of the recording medium S. The dielectric 152 is approximately 250 to 350 mm long, approximately 5 to 15 mm wide, and approximately 1 to 5 mm thick. More specifically, the dielectric 152 is approximately 300 mm long, approximately 10 mm wide, and approximately 3 mm thick. Examples of the material of the dielectric 152 include a dielectric material such as alumina, glass, and mica.

It is sufficient when the discharge electrode 153 and the induction electrode 154 are capable of exhibiting static charge neutralizing capability by being disposed in the dielectric 152 and electricity flowing through the discharge electrode 153 and the induction electrode 154. In the present embodiment, the discharge electrode 153 and the induction electrode 154 are electrically connected to the power supply 158 and electricity flows through the discharge electrode 153 and the induction electrode 154 so that the discharge electrode 153 and the induction electrode 154 exhibit the static charge neutralizing capability. In the present embodiment, the discharge electrode 153 and the induction electrode 154 are linear conductors and are arranged side by side on the dielectric 152 so as to face each other. In addition, the linear conductors may include a plurality of minute protrusions. More specifically, in the present embodiment, the discharge electrode 153 and the induction electrode 154 are arranged side by side in parallel to each other and extend in the longitudinal direction of the dielectric 152. The material of the discharge electrode 153 and the induction electrode 154 may have conductivity. Examples of the material include stainless steel, tungsten, and conductive ceramics.

The discharge electrode 153 and the induction electrode 154 are electrically connected to each other. In the present embodiment, the discharge electrode 153 and the induction electrode 154 are electrically connected to each other via the power supply terminals 155 and 156. Specifically, one end of the discharge electrode 153 and one end of the induction electrode 154 are connected to the power supply terminal 155. In addition, the other ends of the discharge electrode 153 and the induction electrode 154 are connected to the power supply terminal 156. Thus, the discharge electrode 153 and the induction electrode 154 are electrically connected to each other.

It is sufficient when the power supply 158 is capable of applying a voltage to the discharge electrode 153 and the induction electrode 154 to cause electricity to flow. Examples of the power supply 158 include a DC power supply and an AC power supply.

It is preferable that the discharge surface 159 be disposed so as to directly face the image-formed product to be conveyed. That is, it is preferable that no member exist but only air exist between the discharge surface 159 and the recording medium S to be conveyed.

As illustrated in FIG. 2A, the dielectric 152 in which the discharge electrodes 153 and the inductive electrodes 154 are disposed may be disposed both above and below the recording medium S to be conveyed. Thus, static electricity can be removed from above and below the recording medium S. The dielectric 152 in which the discharge electrodes 153 and the induction electrodes 154 are disposed may be disposed only above the recording medium S or may be disposed only below the recording medium S.

The static charge neutralizing unit 150 including the static charge neutralizer 151 as described above may be disposed at any position of the image forming apparatus 100. Specifically, the static charge neutralizing unit 150 may be disposed at any position among the units included in the image forming apparatus 100. More specifically, the static charge neutralizing unit 150 can be disposed between the sheet feed unit 110 and the image forming unit 120. The static charge neutralizing unit 150 can be disposed between the image forming unit 120 and the non-loading unit 130A. The static charge neutralizing unit 150 can be disposed between the non-loading unit 130A and the non-loading unit 130B. The static charge neutralizing unit 150 can be disposed between the non-loading unit 130B and the non-loading unit 130C. The static charge neutralizing unit 150 can be disposed between the non-loading unit 130C and the loading unit 140A. The static charge neutralizing unit 150 can be disposed between the loading unit 140A and the loading unit 140B.

In the example illustrated in FIG. 1A, the static charge neutralizing unit 150 is disposed between the image forming unit 120 and the non-loading unit 130A. In addition, the static charge neutralizing unit 150 is disposed between the non-loading unit 130C and the loading unit 140A. In addition, the static charge neutralizing unit 150 is disposed between the loading unit 140A and the loading unit 140B.

The number of the static charge neutralizing units 150 included in the image forming apparatus 100 is not particularly limited. The image forming apparatus 100 may include static charge neutralizing units 150 between all the units. The image forming apparatus 100 may include the static charge neutralizing unit 150 between specific units.

When the number of the static charge neutralizing units 150 increases, it becomes easier to neutralize a static charge, and it becomes easier for the operation on the recording medium, which is performed in each unit, to be performed without hindrance. On the other hand, when the number of the static charge neutralizing units 150 increases, the cost increases. Accordingly, the static charge neutralizing unit 150 is preferably disposed before a unit at which hindrance occurs in the operation that the recording medium undergoes when a static charge of the recording medium is not neutralized. From this viewpoint, the static charge neutralizing unit 150 is preferably disposed immediately before the loading unit 140A, and is preferably disposed immediately before the loading unit 140B. That is, when a recording medium whose static charge has not been sufficiently neutralized is subjected to the loading operation by the loading unit, the recording medium is not loaded neatly. Specifically, recording media to be loaded may adhere to each other due to static electricity or recording media may not be loaded neatly and orderly, and thus, it is preferable that a static charge be neutralized immediately before the loading unit.

The static charge neutralizer 151 is not particularly limited as long as the static charge neutralizer 151 is disposed at a position where a static charge of the recording medium to be conveyed can be neutralized. The static charge neutralizer 151 is preferably disposed in the conveyance path of the recording medium in the image forming apparatus 100. The method of disposing the static charge neutralizing unit 150 including the static charge neutralizer 151 as described above between the units included in the image forming apparatus 100 to neutralize a static charge of the recording medium is an example of a method of disposing the static charge neutralizer 151 in the conveyance path of the recording medium. The method of disposing the static charge neutralizer 151 in the conveyance path of the recording medium is not limited to the method of disposing the static charge neutralizing unit 150. For example, the static charge neutralizer 151 may be disposed in the conveyance path of the recording medium in each unit (the sheet feed unit 110, the image forming unit 120, the non-loading units 130A, 130B, and 130C, and the loading units 140A and 140B).

As illustrated in FIG. 2A, the static charge neutralizer 151 may include a guide member 160 that guides the recording medium S. The guide member 160 may be appropriately configured so as to be capable of guiding the recording medium S. The guide member 160 is preferably formed of a material having a high wear resistance. The material forming the guide member 160 may include an insulator material and a metal material. Usually, in the case of neutralizing a static charge by corona discharge using needle-like electrodes as in Japanese Patent Application Laid-Open No. 2023-70377 described above, corona discharge is likely to occur between the electrodes and the metal material when the guide member contains a metal material. Then, corona discharge is less likely to occur between the electrodes and the recording medium. Thus, when the guide member contains a metal material, the static charge neutralizing performance may decrease.

However, according to the static charge neutralizer 151 including the dielectric 152 in which the electrodes are disposed as described above, corona discharge occurs in a limited region, so that even when the guide member 160 contains a metal material, a decrease in the static charge neutralizing capability is suppressed. Accordingly, the guide member 160 can contain a metal material. In addition, since metal materials have a high wear resistance, the guide member 160 containing a metal material is less likely to be worn.

The configuration of the guide member 160 is not particularly limited as long as the recording medium S can be conveyed. The guide member 160 illustrated in FIG. 2A is integrally formed with a dielectric supporter 161 and includes the dielectric supporter 161. In addition, the guide member 160 includes a portion which gradually narrows along the conveyance direction of the recording medium S.

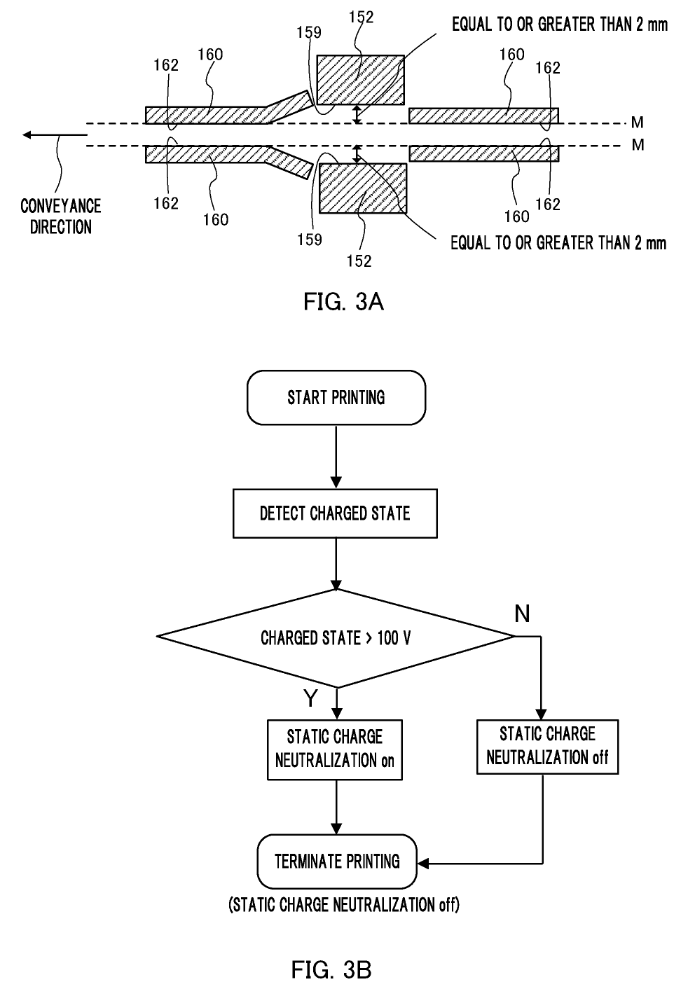

The configuration of the guide member 160 is not limited to the configuration illustrated in FIG. 2A. The configuration of the guide member 160 may be as illustrated in FIG. 3A. That is, the guide member 160 may be a member separate from a dielectric supporter. In the example illustrated in FIG. 3A, the dielectric 152 is supported by a dielectric supporter that is separate from the guide member. Further, as illustrated in FIG. 3A, the guide member 160 may be disposed on the upstream side of the dielectric 152 in the conveyance direction of the recording medium, and may be further disposed on the downstream side of the dielectric 152 in the conveyance direction of the recording medium. The guide member 160 disposed on the upstream side and the guide member 160 disposed on the downstream side may be integrally formed. In such a case, the guide member 160 includes an opening, and the discharge surface 159 of the dielectric is disposed so as to directly face the recording medium with respect to the opening.

The arrangement of the discharge surface 159 of the dielectric 152 may be adjusted as appropriate such that a static charge of the recording medium can be stably neutralized. From the viewpoint of stably exhibiting the static charge neutralizing function, the discharge surface 159 of the dielectric is preferably disposed as described below in relation to the guide member 160 that guides the recording medium. That is, as illustrated in FIGS. 2A and 3A, it is assumed that a virtual surface, which is an extension of a guide surface 162 of the guide member 160, faces the recording medium S, and is substantially parallel to the recording medium, is a virtual extension surface M. At this time, the distance in the direction perpendicular to the virtual extension surface M between the virtual extension surface M and the discharge surface 159 (hereinafter, this distance will be referred to as the discharge distance) is preferably equal to or greater than 2 mm. On the other hand, as the discharge distance becomes larger, the static charge neutralizing capability becomes gradually weaker. For this reason, the discharge distance is preferably equal to or less than 15 mm, more preferably equal to or less than 10 mm, and still more preferably equal to or less than 5 mm. Note that, this preferable discharge distance applies to both the discharge surfaces 159 disposed above and below the recording medium S. In addition, details of the above will be described later with reference to Example.

The activation of the static charge neutralizer 151 may be appropriately adjusted according to the charged state of the recording medium S. FIG. 3B illustrates a flowchart in a case where the activation of the static charge neutralizer 151 is appropriately adjusted according to the charged state. As illustrated in FIG. 3B, first, printing is started (image formation is started). Next, the charged state of the recording medium on which an operation has been performed at the image forming apparatus 100 is detected. Next, it is determined whether the detected charged state exceeds the 100 V or not. In a case where the detected charged state does not exceed 100 V, the recording medium S is conveyed without activating the static charge neutralizer 151. In a case where the detected charged state exceeds 100 V, on the other hand, the recording medium S is conveyed in a state in which the static charge neutralizer 151 is activated. As described above, it is possible to save energy of the image forming apparatus 100 by switching static charge neutralization by the static charge neutralizer 151 on or off according to the charged state. Note that, the criterion for determining whether to activate the static charge neutralizer 151 or not is not limited to whether the detected charged state exceeds 100 V or not, and may be adjusted as appropriate. Specifically, the activation of the static charge neutralizer 151 can be performed via a controller 10 illustrated in FIG. 1A. The controller 10 is, for example, a computer capable of executing a program.

For the detection of the charged state, a charged state detecting means known in the art, which is disposed upstream of the static charge neutralizer 151, may be used. Examples of the charged state detector include an apparatus capable of measuring the potential, voltage, and the like of the recording medium. In addition, the charged state detecting means can be disposed immediately before the static charge neutralizer 151.

### Other Units

Hereinafter, the units other than the static charge neutralizing unit 150 included in the image forming apparatus 100 will be described.

### Sheet Feed Unit

The sheet feed unit 110 feeds a recording medium to the image forming unit 120. The sheet feed unit 110 is not particularly limited as long as the sheet feed unit 110 is capable of feeding a recording medium. The sheet feed unit 110 is a unit located most upstream of the image forming apparatus 100.

### Image Forming Unit

The image forming unit 120 forms an image on a recording medium. A method by which the image forming unit 120 forms an image is not particularly limited. Image forming methods of the image forming unit 120 include an electrostatic photographic method, an electrophotographic method, an inkjet method, and the like.

### Non-Loading Unit

The non-loading units 130A to 130C perform various operations other than loading, if necessary, on a recording medium on which an image has been formed (image-formed product). In the image forming apparatus 100 illustrated in FIG. 1A, the non-loading unit 130A corrects a curl of the image- formed product. The non-loading unit 130B detects the position where the image of the image-formed product has been formed. The non-loading unit 130C folds the image-formed product. Examples of the folding include bi-fold, tri-fold, gate-fold, and the like. The folded image-formed product is bound as will be described later.

### Loading Unit

The loading units 140A and 140B load the image-formed product. The loading unit 140A has a function to bind the image-formed product, which has been folded by the non-loading unit 130C, by case binding, saddle stitching, multi-folding, or the like. The bound image-formed product is loaded by the loading unit 140A. At this time, when a static charge of the image-formed product has been neutralized, it is easy to bind the image-formed product. In particular, when the static charge neutralization is performed by the static charge neutralizing unit 150 disposed immediately before the loading unit 140A, it is easy to bind the image-formed product. The loading unit 140B loads the image-formed product that is not folded. At this time, when a static charge of the image-formed product has been neutralized, image-formed products are likely to overlap each other neatly. In particular, when the static charge neutralization is performed by the static charge neutralizing unit 150 disposed immediately before the loading unit 140A, it is easy to load the image-formed product.

### Effects

According to the image forming apparatus 100 according to the present embodiment, the static charge neutralizer 151 includes the dielectric 152 in which electrodes are disposed. Thus, the static charge neutralizer 151 is compact and is easily installed in a limited space. In addition, in the static charge neutralizer 151, discharge is performed in a narrow range. Thus, the guide member 160 that conveys the recording medium to the static charge neutralizer 151 can be formed of a material containing metal. In addition, the durability of the guide member 160 can be increased thereby. In addition, in the static charge neutralizer 151, discharge is performed in a narrow range, and thus, the risk of electric shock or the like is low, and safety is high. In addition, the image forming method using the image forming apparatus according to the present embodiment causes a static charge of an image-formed product to be neutralized, and thus, an image-formed product is likely to be neatly loaded.

### Example

Hereinafter, the present invention will be specifically described with reference to Example, but the present invention is not limited to the following Example.

An image forming apparatus including a static charge neutralizing unit was prepared, and an experiment for examining the static charge neutralizing capability was conducted. In particular, an experiment was conducted to examine the relationship between the above-described discharge distance and the static charge neutralizing capability of the static charge neutralizing unit.

Specifically, ION BLADE F2 manufactured by FISA Corporation was used as a static charge neutralizer to produce a static charge neutralizing unit including the static charge neutralizer above the conveyance path of the recording medium. The produced static charge neutralizing unit was disposed immediately before the loading unit 140B of the image forming apparatus to prepare the image forming apparatus. In the prepared image forming apparatus, one sheet of AURORA COAT, which is coated paper manufactured by Nippon Paper Industries Co., Ltd., was conveyed as a recording medium. An image was formed on the sheet to be conveyed by the image forming unit, and the sheet was conveyed to the loading unit 140B through the loading unit 140A without performing an operation at the non-loading unit. The charged state of the sheet at the loading unit 140B this time was detected using SK-1000 manufactured by Keyence Corporation, which is an electrostatic measuring machine, as a charged state detecting means.

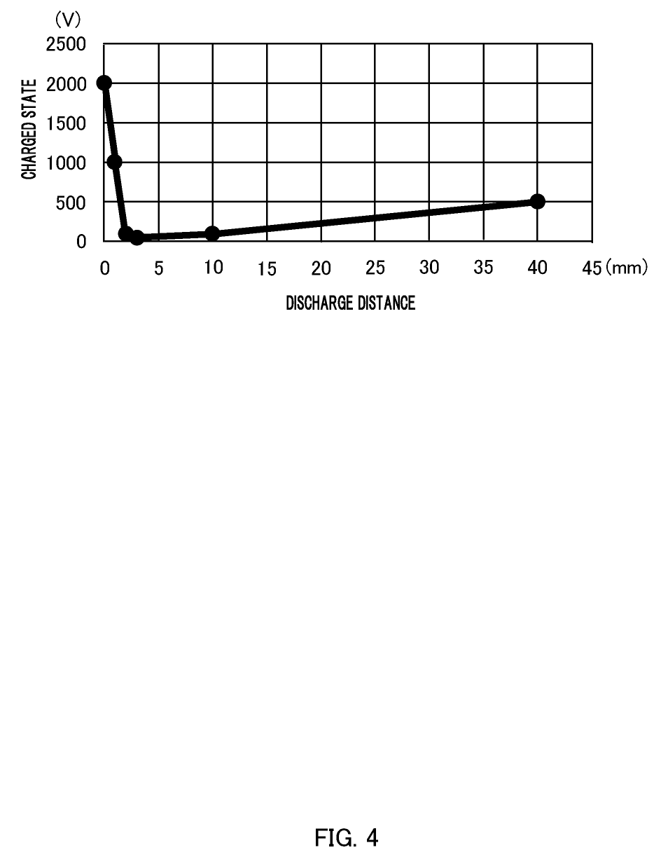

Note that, in the conveyance of the sheet as described above, changes in the charged state were measured by changing the discharge distance for the static charge neutralizer, which was disposed above the recording medium, between 0 mm and 40 mm. The measurement results are illustrated in the graph of FIG. 4.

As can be seen from the graph of FIG. 4, when the discharge distance was between 0 mm and 3 mm, the charged state rapidly changed from 2000 V to 0 V and the static charge neutralizing capability rapidly increased as the discharge distance increased. Note that, the static charge neutralizing capability was highest when the discharge distance was 3 mm. On the other hand, as can be seen from the graph of FIG. 4, when the discharge distance was between 3 mm and 40 mm, the charged state gradually changed from 0 V to 40 V and the static charge neutralizing capability gradually decreased as the discharge distance increased.

From the graph of FIG. 4, it has been found that the discharge distance is preferably equal to or greater than 2 mm from the viewpoint of exhibiting a stable static charge neutralizing capability. This is because when the discharge distance is smaller than 2 mm, the static charge neutralizing capability rapidly decreases. On the other hand, when the discharge distance increases beyond 3 mm, the static charge neutralization capability gradually decreases. Accordingly, from the viewpoint of exhibiting a sufficient static charge neutralization capability, it has been found that the discharge distance is preferably equal to or less than 15 mm, more preferably equal to or less than 10 mm, and still more preferably equal to or less than 5 mm.

### Industrial Applicability

The present invention is applicable to, for example, an image forming apparatus that forms an image by an electrophotographic method.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising a static charge neutralizer that neutralizes a static charge of a recording medium to be conveyed, wherein
the static charge neutralizer includes a dielectric, a discharge electrode, and an induction electrode, the discharge electrode and the induction electrode being disposed in the dielectric.

2. The image forming apparatus according to claim 1, further comprising a guide member that guides the recording medium, wherein the guide member contains a metal material.

3. The image forming apparatus according to claim 1, wherein a distance in a direction perpendicular to a virtual extension surface between a discharge surface of the static charge neutralizer and the virtual extension surface is greater than or equal to 2 mm, the virtual extension surface being an extension of a guide surface of a guide member that guides the recording medium.

4. The image forming apparatus according to claim 1, wherein a discharge surface of the static charge neutralizer is disposed so as to directly face the recording medium to be conveyed.

5. The image forming apparatus according to claim 1, comprising a pair of the static charge neutralizers disposed at positions facing each other with the recording medium to be conveyed passing between the positions.

6. The image forming apparatus according to claim 1, further comprising a charged state detecting means that detects a charged state of the recording medium upstream of the static charge neutralizer.

7. The image forming apparatus according to claim 6, wherein static charge neutralization by the static charge neutralizer is switched on or off according to the charged state detected by the charged state detecting means.

8. The image forming apparatus according to claim 1, wherein the static charge neutralizer is disposed downstream of an image forming unit that forms an image.

9. The image forming apparatus according to claim 1, wherein the static charge neutralizer is disposed immediately before a loading unit that loads the recording medium.

10. The image forming apparatus according to claim 1, wherein the static charge neutralizer is disposed in a static charge neutralizing unit that neutralizes the static charge of the recording medium.

11. An image forming method, using the image forming apparatus according to claim 1.
